(19) United States
(12) Patent Application Publication
(10) Pub. No.: US 2005/0190193 A1
(43) Pub. Date: Sep. 1, 2005

(54) Apparatus and a method to adjust signal timing on a memory interface

(76) Inventors: David E. Freker, Sacramento, CA (US); Zohar Bogin, Folsom, CA (US); Dour Navneet, Folsom, CA (US); Anoop Mukker, Folsom, CA (US); Tuong P. Trieu, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/791,180

(22) Filed: Mar. 1, 2004

(51) Int. Cl. G06F 13/00; G06F 13/372

(52) U.S. Cl. 345/534

(57) ABSTRACT

An apparatus and a method for adjusting signal timing in a memory interface have been disclosed. One embodiment of the apparatus includes a number of slave delay lock loops (DLLs) in a memory interface to adjust timing between a number of signals to compensate for timing skew, and a number of input/output (I/O) buffers to output the adjusted signals to one or more memory devices coupled to the memory interface. Other embodiments are described and claimed.

### FIELD OF INVENTION

The present invention relates generally to computer systems, and more particularly, to adjusting signal timing in an interface of a semiconductor device.

### BACKGROUND

In an exemplary computer system, a memory controller has a memory interface to send memory control signals and data signals to one or more memory devices. Examples of the memory control signals include chip select (CS#), write enable (WE#), memory commands (RAS# and CAS#), clock (CK), etc.

However, the timing of the control signals may be skewed for various reasons. For example, in a computer system having a large number of memory chips, the memory controller may generate multiple copies of CK to input to the memory chips in parallel. But some of the control signals, such as CS#, may not have multiple copies generated because of resource constraints. Therefore, CS# is sent to the memory chips within a memory module serially. Since there is a large number of memory chips and CS# is sent to the memory chips one by one, some of the memory chips may receive CS# later than other memory chips within the same memory module. The timing skew between CS# and CK in these memory chips may cause these memory chips to function incorrectly.

Furthermore, other problems may also cause timing skew in a computer system having a small number of memory chips. For instance, the timing of signal transmission depends on the length of the trace line via which the signal travels. When the trace line of a first signal is longer than the trace line of a second signal, the first signal may arrive at a memory device later than the second signal even though both signals may have been sent simultaneously.

An existing solution to reduce the impact of timing skew in control and data signals sent to memory devices involves lowering the frequency of the memory clock. However, as the speed of the computer system increases, it has become impractical, if not infeasible, to lower the frequency of the memory clock in order to reduce the impact of signal timing skew.

### BRIEF DESCRIPTION OF THE DRAWINGS

The present invention will be understood more fully from the detailed description that follows and from the accompanying drawings, which however, should not be taken to limit the appended claims to the specific embodiments shown, but are for explanation and understanding only.

FIG. 1 illustrates one embodiment of a memory interface.

FIG. 2A illustrates one embodiment of a slave delay lock loop.

FIG. 2B illustrates one embodiment of a master delay lock loop.

FIG. 3 shows a flow diagram of one embodiment of a process for adjusting signal timing in a memory interface.

FIG. 4 illustrates an exemplary embodiment of a computer system.

### DETAILED DESCRIPTION

In the following description, an apparatus and a method to adjust signal timing on a memory interface have been disclosed. Numerous specific details are set forth below. However, it is understood that embodiments of the invention may be practiced without these specific details. In other instances, well-known circuits, structures, and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

Some portions of the following detailed description are presented in terms of symbolic representations of operations on data bits within a computer memory. These descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention may also relate to an apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, also referred to as a machine-accessible medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The operations and displays presented herein are not inherently related to any particular computer or other apparatus. Various general-purpose systems may be used with programs in accordance with the teachings herein, or it may prove convenient to construct more specialized apparatus to perform the operations described. The required structure for a variety of these systems will appear from the description below. In addition, embodiments of the present invention may not be described with reference to any particular programming language. It will be appreciated that a variety of programming languages may be used to implement the teachings of the invention as described herein.

A “machine-accessible medium,” as the term is used in this document, includes any mechanism for storing or transmitting information in a form readable by a machine (e.g., a computer). For example, a machine-readable medium includes ROM; RAM; magnetic disk storage media; optical storage media; flash memory devices; electrical, optical, acoustical or other form of propagated signals (e.g., carrier waves, infrared signals, digital signals, etc.); etc.

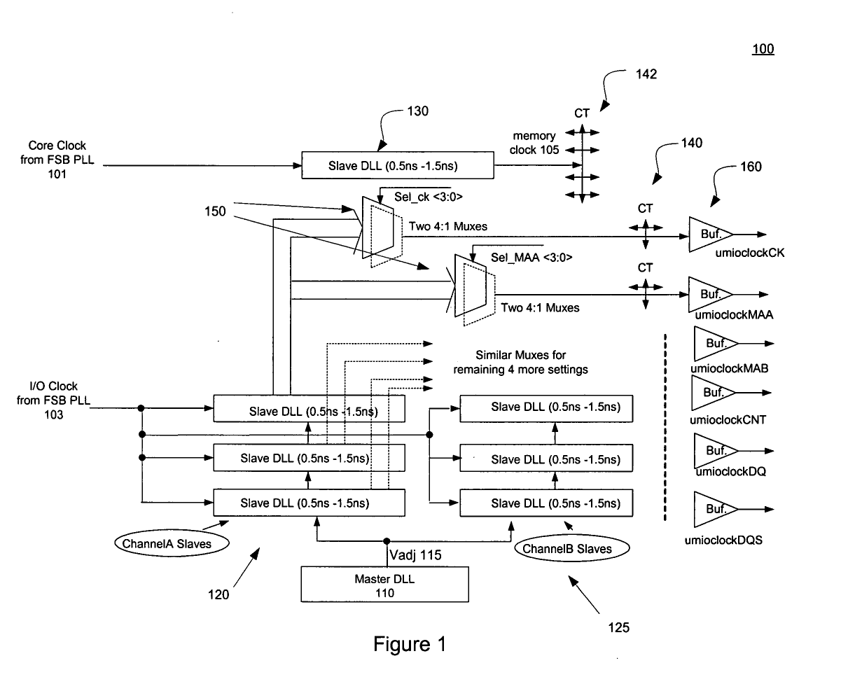

FIG. 1 illustrates one embodiment of a memory interface in a memory controller. The memory interface 100 includes a master delay lock loop (DLL) 110, a number of slave DLLs 120 and 125 for a number of control and data signals, a slave DLL 130 for a memory clock signal, a number of clock trees 140 and 142, a number of multiplexers (MUX) 150, and a number of input/output (I/O) buffers 160. The memory interface 100 may receive a core clock signal 101 and an I/O clock signal 103 from a front side bus (FSB) phase lock loop (PLL) (not shown) in the memory controller.

The I/O clock signal 103 is input to the slave DLLs 120 and 125, which are also referred to as delay lines. The slave DLLs 120 and 125 may be divided into a number of groups, each group designated to a different memory channel. For example, referring to FIG. 1, the three slave DLLs 120 on the left are designated to the memory channel A and the other three slave DLLs 125 on the right are designated to the memory channel B. As discussed above, the control and data signals (e.g., CS#, CK, CE#, DQ, DQS, etc.) sent by the interface 100 to memory devices may have timing skew due to various reasons. The slave DLLs 120 and 125 adjust the timing between each of the control and data signals to compensate for the timing skew that may exist between the signals. In one embodiment, a number of configurations bits are programmed according to instructions stored in a basic input/output system (BIOS) at the powering up of the memory controller. Based on the setting of the configurations bits, the delay of each of the slave DLLs 120 and 125 is set. The granularity of the delay setting may be at approximately 50 psec to 100 psec. Furthermore, the higher the frequency of the I/O clock signal 103, the finer the granularity may be. More detail of an exemplary slave DLL will be discussed below.

Referring back to FIG. 1, the core clock signal 101 is input to the slave DLL 130. The slave DLL 130 adjusts the timing of the core clock signal 101 in response to the amounts of delay of the slave DLLs 120 to generate a memory clock signal 105. In one embodiment, the delay of the slave DLL 130 is adjusted to be substantially equal to the largest delay among the delays of the slave DLLs 120 and 125 to prevent hold time violation of the control and data signals from the core of the memory controller to the I/O buffers 160. The output of the slave DLL 130 may be coupled to a clock tree 142, which generates multiple copies of the memory clock signal 105 sent to the memory devices.

The memory interface 100 further includes a master DLL 110, which calibrates the slave DLLs 120, 125, and 130. The master DLL 110 adjusts a voltage, Vadj 115, until a predetermined delay is achieved. Vadj 115 is input to the slave DLLs 120, 125, and 130 to set the granularity of the delay adjustment of the slave DLLs 120, 125, and 130. More details of the master DLL 110 will be discussed below.

Referring back to FIG. 1, an output of each of the slave DLLs 120 and 125 is coupled to two sets of multiplexers. For instance, the output of the slave DLL 112 is coupled to the multiplexers 150. However, not every multiplexer in the memory interface 100 is shown in FIG. 1 to avoid obscuring the view. The outputs of the multiplexers 150 are coupled to the I/O buffers 160. In one embodiment, each of the slave DLLs 120 and 125 supports two signal groups, and thus, each of the slave DLLs 120 and 125 is coupled to two of the I/O buffers 160 via two sets of the multiplexers 150.

The clock trees 140 clock the I/O buffers 160 to send the control and data signals from the I/O buffers 160 to the memory devices. Adjusting the timing between the signals before sending the signals to the memory devices may compensate for the timing skew between the signals, and thus, may allow the edges of the signals to be substantially aligned for correct operation when the signals arrive at the memory devices.

In sum, the slave DLLs 120 and 125 are coupled to the roots of the individual clock trees 140, which then clock the corresponding I/O buffers 160 in the memory interface 100. As a result, the timing between the control and data signals may be adjusted to compensate for the timing skew of one or more of the signals. The compensation of the timing skew enables the memory controller and the memory devices to operate at higher frequency. The compensation of the timing skew also allows the memory controller to operate with more memory devices installed in a memory module without violating the signal timing requirements of the memory devices.

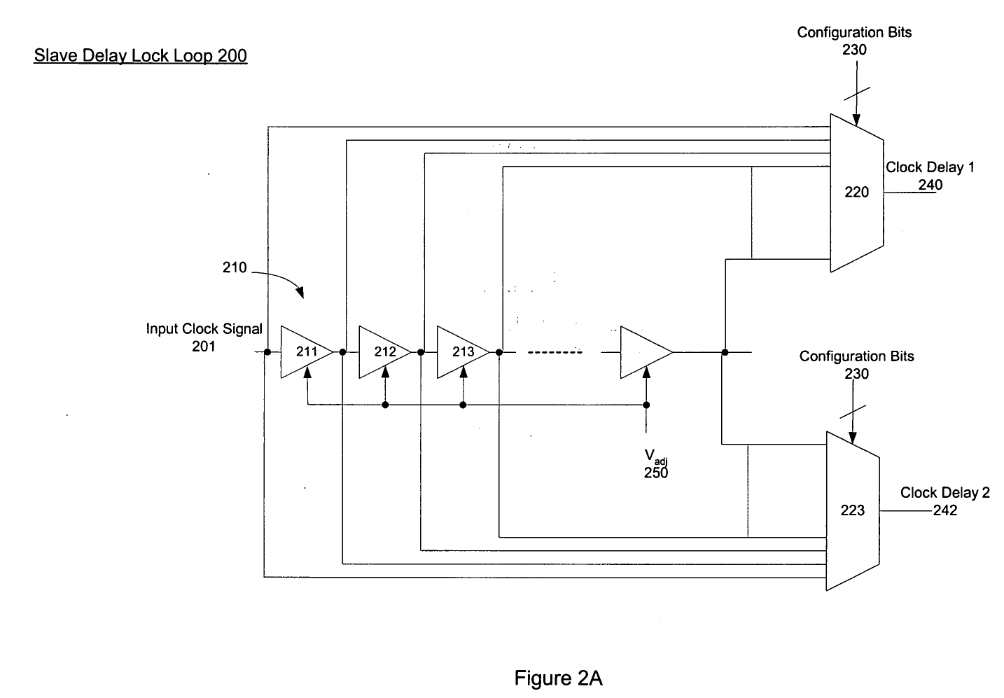

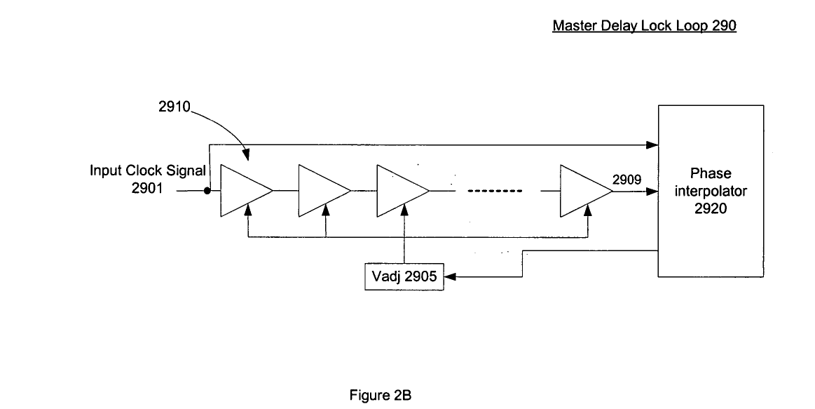

FIG. 2A shows one embodiment of a slave DLL. The slave DLL 200 includes a number of buffers 210, each forming a stage in the slave DLL 200. The buffers 210 are coupled to each other in series. A reference voltage (V_{adj}) 250 is input to each buffer 210. In response to Vref 250, each of the buffers 210 delays the input signal by a corresponding amount of time and outputs the delayed signal. For instance, the delay of each buffer may be 50 psec. Then the input clock signal 201 is delayed by

50 psec at the output of the first buffer 211, 100 psec at the output of the second buffer 212, 150 psec at the output of the third buffer 213, and so on.

Referring to FIG. 2A, the slave DLL 200 further includes a multiplexer 220, which selects one of the outputs of the buffers 210 based on the setting of the configuration bits 230. In one embodiment, the configuration bits 230 are set according to instructions stored in the BIOS at the powering up of the memory controller. The output of the multiplexer 220 is the delayed clock signal, Clock Delay 1 240. Likewise, the multiplexer 223 is coupled to the buffers 210 to select one of the outputs of the buffers to generate the second delayed clock signal, Clock Delay 2 242, in a way similar to the multiplexer 220.

One should appreciate that the slave DLL 200 may include additional multiplexers coupled to the outputs of the buffers 210 in a way similar to the multiplexers 220 and 223. The additional multiplexers may generate additional delayed clock signals to support more signal groups.

FIG. 2B illustrates a master DLL. The master DLL 290 includes a number of buffers 2910 and a phase interpolator 2920. The buffers 2910 are coupled to each other in series, each delaying the corresponding input signal in response to the input reference voltage, Vadj 2905. The input clock signal 2901 and the output of the last buffer 2909 are input to the phase interpolator 2920. Based on the delay between the input clock signal 2901 and the output of the last buffer 2909, the phase interpolator 2920 adjusts Vadj 2905 in order to match the phases between the input clock signal 2901 and the output of the last buffer 2909. Such calibration of Vadj 2905 may continue until each of the buffers 2910 provides an amount of delay so that the total delay may equal one period of the input clock. In one embodiment, the delay provided by each of the buffers 2910 is approximately 50 psec.

When the phases match, the master DLL 290 applies the calibrated Vadj 2905 to the slave DLLs (such as the slave DLLs 120 and 125 in FIG. 1) such that each stage in each slave DLL provides substantially the same amount of delay as the stages of the master DLL 290.

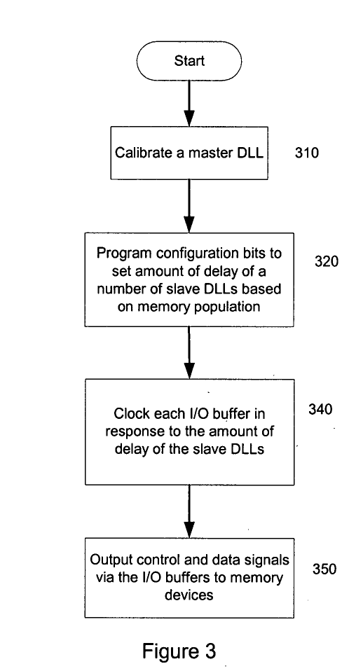

FIG. 3 illustrates a flow diagram of one embodiment of a process for adjusting signal timing in a memory interface. The process is performed by processing logic that may comprise hardware (e.g., circuitry, dedicated logic, etc.), software (such as is run on a general purpose computer system or a dedicated machine), or a combination of both.

Processing logic calibrates a master DLL (processing block 310). Then processing logic programs configuration bits to set the amount of delay of each of a set of slave DLLs (processing block 320). In one embodiment, processing logic programs the configuration bits based on the memory population. Processing logic may also sets the amount of delay of a slave DLL to adjust the timing of a core clock signal to generate a memory clock signal. Processing logic then clocks each I/O buffer in the memory interface in response to the amount of delay of the slave DLLs (processing block 340). Finally, processing logic outputs the control and data signals via the I/O buffers to the memory devices (processing block 350).

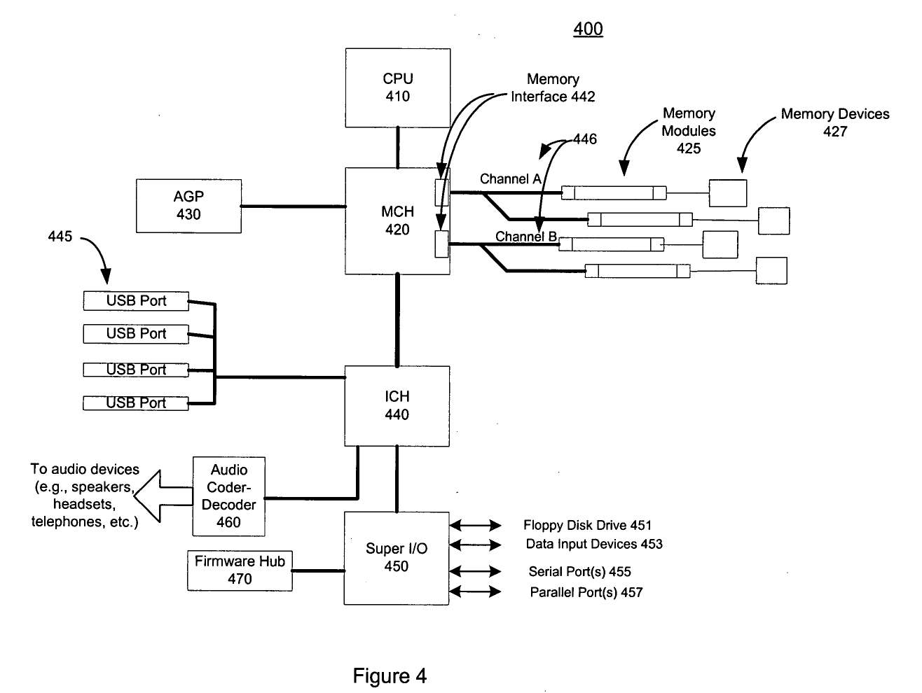

FIG. 4 shows an exemplary embodiment of a computer system 400. The computer system 400 includes a central processing unit (CPU) 410, a memory controller (MCH) 420, a number of memory modules 425 (e.g., dual-inline memory modules, also referred to as DIMMs), a number of memory devices 427, a graphic port (AGP) 430, an input/output controller (ICH) 440, a number of Universal Serial Bus (USB) ports 445, an audio coder-decoder 460, a Super Input/Output (Super I/O) 450, and a firmware hub (FWH) 470.

In one embodiment, the CPU 410, the graphic port 430, the memory modules 425, and the ICH 440 are coupled to the MCH 420. The MCH 420 routes data to and from the memory devices 427 via the memory modules 425. The memory devices 427 may include various types of memories, such as, for example, dynamic random access memory (DRAM), synchronous dynamic random access memory (SDRAM), double data rate (DDR) SDRAM, or flash memory. In one embodiment, each of the memory modules 425 is mounted on the same motherboard (not shown) via a memory module connector (not shown) in order to couple to the MCH 420. In one embodiment, the USB ports 445, the audio coder-decoder 460, and the Super I/O 450 are coupled to the ICH 440. The Super I/O 450 may be further coupled to a firmware hub 470, a floppy disk drive 451, data input devices 453, such as, a keyboard, a mouse, etc., a number of serial ports 455, and a number of parallel ports 457. The audio coder-decoder 460 may be coupled to various audio devices, such as speakers, headsets, telephones, etc.

The MCH 420 includes a memory interface 442 for each of the memory channels 446. In one embodiment, the memory devices 427 include DDR SDRAM devices and the memory modules 425 include DDR DIMMs. Referring to FIG. 4, the computer system 400 has two memory channels 446, namely, Channel A and B. Each of the memory channels 446 is coupled to the MCH 420 via one of the memory interface 442 in the MCH 420. Detail of some embodiments of the memory interface 442 has been discussed above.

One should appreciate that the MCH 420 and the CPU 410 may be integrated into a single semiconductor chip in another embodiment of the computer system. Alternatively, the MCH 420 and the ICH 440 may be integrated into a single semiconductor chip. Nevertheless, the technique disclosed herein is applicable to these configurations as well.

Note that any or all of the components and the associated hardware illustrated in FIG. 4 may be used in various embodiments of the computer system 400. However, it should be appreciated that other configurations of the computer system may include one or more additional devices not shown in FIG. 4. Furthermore, one should appreciate that the technique disclosed is applicable to different types of system environment, such as a multi-drop environment or a point-to-point environment. Likewise, the disclosed technique is applicable to both mobile and desktop computing systems.

The foregoing discussion merely describes some exemplary embodiments of the present invention. One skilled in the art will readily recognize from such discussion, the accompanying drawings and the claims that various modifications can be made without departing from the spirit and scope of the appended claims. The description is thus to be regarded as illustrative instead of limiting.

1. An apparatus comprising:
a plurality of slave delay lock loops (DLLs) in a memory interface to adjust timing between a plurality of signals to compensate for timing skew; and
a plurality of input/output (I/O) buffers to output the plurality of signals to one or more memory devices coupled to the memory interface after adjusting the timing.

2. The apparatus of claim 1, further comprising a plurality of programmable configuration bits, coupled to the plurality of slave DLLs, to set an amount of delay each of the plurality of slave DLLs applies to one of the plurality of signals.

3. The apparatus of claim 2, further comprising a slave DLL to adjust timing of a core clock signal in response to the amount of delay each of the plurality of slave DLLs applies to one of the plurality of signals to generate a memory clock signal.

4. The apparatus of claim 1, further comprising a master DLL, coupled to the plurality of slave DLLs, to calibrate the plurality of slave DLLs.

5. The apparatus of claim 1, further comprising a plurality of multiplexers to couple each of the plurality of slave DLLs to one or more of the plurality of I/O buffers.

6. The apparatus of claim 1, further comprising a plurality of clock trees, each of the plurality of clock trees having a root coupled to an output of each of the plurality of slave DLLs, to clock each of the plurality of I/O buffers.

7. The apparatus of claim 1, wherein the plurality of signals includes a plurality of memory control signals.

8. A method comprising:
adjusting timing between a plurality of signals using a plurality of slave delay lock loops (DLLs) in a memory interface before sending the signals to one or more memory devices; and
sending the plurality of signals to the one or more memory devices.

9. The method of claim 8, wherein adjusting the timing comprises:
programming a plurality of configuration bits to set an amount of delay each of the plurality of slave DLLs applies to one of the plurality of signals, the plurality of configuration bits being coupled to the plurality of slave DLLs.

10. The method of claim 9, further comprising adjusting timing of a core clock signal using a slave DLL in response to the amount of delay each of the plurality of slave DLLs applies to one of the plurality of signals to generate a memory clock signal.

11. The method of claim 9, further comprising ting timing of a core clock signal in response to the plurality of configuration bits.

12. The method of claim 8, further comprising calibrating the plurality of slave DLLs using a master DLL.

13. The method of claim 8, further comprising clocking each of a plurality of input/output (I/O) buffers to output the plurality of signals in response to the amount of delay each of the plurality of slave DLLs applies to one of the plurality of signals.

14. The method of claim 8, wherein the plurality of signals includes a plurality of memory control signals.

15. A machine-accessible medium that provides instructions that, if executed by a processor, will cause the processor to perform operations comprising:
programming a first plurality of configuration bits in a memory interface; and
causing a plurality of slave delay lock loops (DLLs) in the memory interface to adjust timing between a plurality of signals in response to the plurality of configuration bits before the plurality of signals are sent to one or more memory devices.

16. The machine-accessible medium of claim 15, wherein the operations further comprise:
programming a second plurality of configuration bits of a master DLL; and
causing the master DLL to calibrate the plurality of slave DLLs in response to the second plurality of configuration bits.

17. The machine-accessible medium of claim 16, wherein the operations further comprise programming a third plurality of configuration bits to adjust timing of a core clock signal using a slave DLL in response to the timing of the plurality of slave DLLs to generate a memory clock signal to be sent to the one or more memory devices.

18. A system comprising:
a graphics chip;
a plurality of memory devices; and
a memory controller coupled to the plurality of memory devices and the graphics chip, the memory controller having a memory interface that comprises
a plurality of slave delay lock loops (DLLs) to adjust timing between a plurality of signals to compensate for timing skew; and
a plurality of input/output (I/O) buffers to output the plurality of signals to one or more of the plurality of memory devices after adjusting the timing.

19. The system of claim 18, wherein the plurality of signals includes a plurality of memory control signals.

20. The system of claim 18, wherein the memory interface further comprises a master DLL to calibrate the plurality of slave DLLs, the master DLL is coupled to the plurality of slave DLLs.

21. The system of claim 18, further comprising a processor coupled to the memory controller.

22. The system of claim 18, wherein the plurality of memory devices includes a plurality of double-data rate (DDR) dynamic random access memory (DRAM) devices.
